(19) United States
(12) Patent Application Publication
(10) Pub. No.: US 2006/0112634 A1
(43) Pub. Date: Jun. 1, 2006

(54) Self watering plant receptacle

(76) Inventor: Paul Andrew Vogt, W. St. Paul, MN (US)

Correspondence Address: PAUL ANDREW VOGT, 1058 OTTAWA AVE., W. ST. PAUL, MN, 55118, US

(21) Appl. No.: 10/978,858

(22) Filed: Nov. 2, 2004

(51) Int. Cl. A01G 25/00

(52) U.S. Cl. 47/81

(57) ABSTRACT

A plant receptacle comprised of several compatible portions which work in unison to readily supply water as needed to a plant for several days. An upper portion of designed plant container would act to hold soil and contain an absorptive matter portion, which would protrude from its base area, and would act to wick water from a connectable lower portion which would act to encapsulate a volume of water, and when mated, a gap of sort is thus formed for refilling the created water reservoir.

### BACKGROUND OF THE INVENTION

The invention at hand is relative to plants which are restrained to a limited growing environment, in essence, to a distinct self watering plant receptacle which could sustain life to a wide variety of plants from multiple origins for an extended period of time without daily human assistance.

While potted plants are virtually in every home and business throughout the world, they often times present quite a challenge seeing the vast majority of contained plants need constant tending. This holds true mainly because these minimal growing environs cannot sustain an adequate supply of water for an extended period of time.

Although a variety of plant containers have been developed over the years, they have predominantly relied on the soil capacity as a means for water saturation (content).

Applicant is also aware of other plant containers that have introduced water catch basins or bowls in an attempt to capture more moisture, but all rely on a plants roots to invade such areas which inevitably put a plant's livelihood in jeopardy due to several funguses which can incur, as can such designs starve a plants soil area of oxygen due to over saturation.

With the exception of the foregoing plant containers, applicant is unaware of any other self watering wick type plant receptacle, other than an earlier model he developed which is under examination by the U.S. Patent and Trademark Office at the current time, (year 2004).

Applicant accordingly believes a need exists for self watering plant receptacles which would sustain plants for prolonged periods of time, allowing them to become more self-sufficient.

Applicant also wishes to disclose, previously filed is U.S. patent application Ser. No. 10/797,277, filing dated Mar. 11, 2004.

### SUMMARY OF THE INVENTION

According to the present invention, a self watering plant receptacle which can sustain the life of a plant for several days between tending is provided, that comprises a container consisting of several compatible portions, an upper portion which acts to hold soil and capture an absorptive matter portion which projects through its base, while an attachable lower portion would act as an enclosed water reservoir that when mated would yield a gap of sort for refilling the established water reservoir.

The absorptive matter portion of the present invention can be of a cotton type rope, sponge, compressed particle, woven material, or other absorbent substance that would draw water up from an attached lower water reservoir portion to replenish the upper soil containment portion in turn providing a plant with a steady supply of moisture for a lengthy period of time.

It is accordingly a primary object of the invention to provide a multi-piece receptacle having a lower water reservoir portion being connectable to an upper soil containment portion with a means for fastening a plant container hanger of sort.

The compatible portions of the embodiment are of a molded plastic material, wherein a means of coupling the two portions is achieved, and where within, a way to capture an absorptive matter portion is accomplished, and wherefrom a hanger of sort could be attached.

In one embodiment of the present invention, a series of holes in the base of the upper soil portion are introduced in order to capture an absorptive matter portion and to produce a means of attachment for the lower water reservoir portion having barbed projections extending from its sidewalls and an outward protrusion in its sidewall would in effect enable refilling of the coupled water reservoir. Also a means of connecting a plant container hanger is established.

In another embodiment, a means to capture an absorptive matter portion in the base of the upper soil portion would be made by way of one or more openings having spiked projections, and a method of mating the lower water reservoir portion would be accomplished by an area of recess, or recessed points in the base of the upper soil portion for receiving protrusions on the upper region of the lower water reservoir portion enticing connection. The upper soil portion also includes a concave in its sidewall which would permit refilling of the lower water reservoir portion while connected.

In yet another embodiment, the lower water reservoir portion establishes a sidewall opening or gap for refilling with water, and optional means of coupling to the upper soil portion of the receptacle.

The preceding scope of the invention, will become more evident hereinafter with reference to the upcoming descriptions thereof with respect to the appended drawings.

### BRIEF DESCRIPTION OF THE DRAWINGS

FIG. 1 shows an isometric view of a self watering plant receptacle having a lower water reservoir portion including water refilling gap, connected to a compatible upper soil portion having a means for hanger attachment.

FIG. 2 shows an isometric view of the present invention wherein the upper soil portion are means for capturing an absorptive matter portion for wicking water, also coupling means for a compatible lower water reservoir portion with refilling gap, and means for optional hanger attachment.

FIG. 3 shows an isometric view of an alternative lower water reservoir portion having a stepped sidewall wherein the upper soil portion would nestle and wherefrom is a gap for refilling reservoir with water.

FIG. 4 shows an isometric view of an alternative multi-part self watering plant receptacle wherein the upper soil retaining portion has accommodating means for attaching lower water reservoir portion, and also a concave in its sidewall to enable refilling of water reservoir portion.

FIG. 5 shows an isometric view of a formed absorptive matter portion mountable in upper soil portion of FIGS. 1, 2, 4, and 6.

FIG. 6 shows an isometric view of another variation of embodiment of the present invention having an absorptive matter portion protruding from the base of the upper soil portion with alternative coupling means for lower water reservoir portion.

### DESCRIPTION OF THE PREFERRED EMBODIMENT

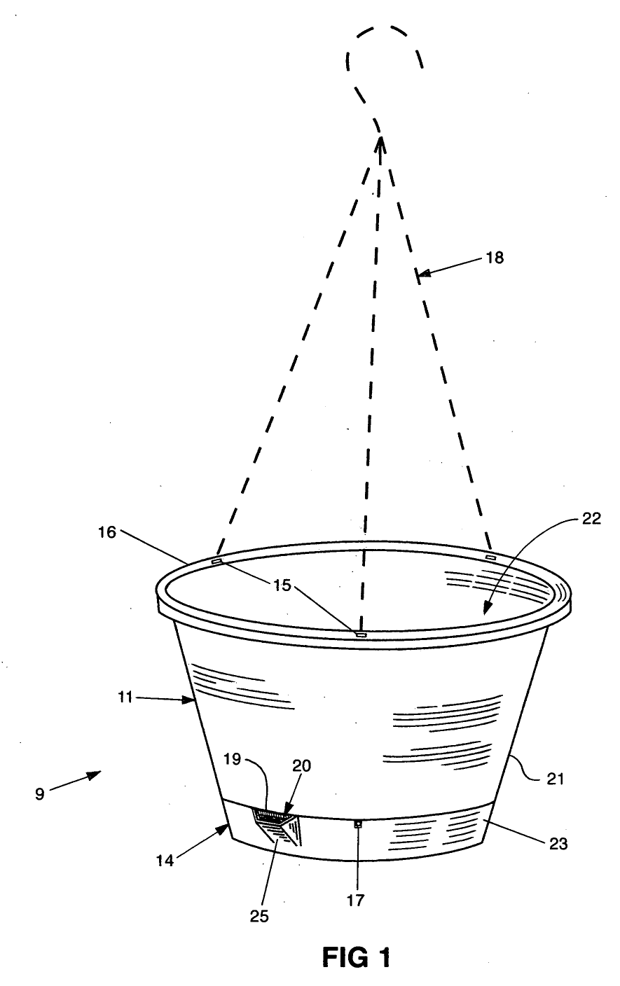

Referring to FIG. 1, an isometric view is shown of a presently preferred, self watering plant receptacle assembly 9. The receptacle 9 is generally constructed as a multi-piece assembly providing an upper soil portion 11 having a sizeable basin 22 for holding soil. Protruding outwardly from the uppermost extremity of sidewall 21 is a rim 16 containing pits 15 that would allow optional hanger 18 (shown in outline), attachment. On the lower extremity of the sidewall 21 are coupling joints 17 which would interact with opposite male or female counterparts formed on the upper region of the lower water reservoir portion 14 sidewall 23, enabling connection.

The reservoir portion 14 being more or less bowl shaped, produces an enclosed hollow 19 meant to contain a volume of water below the upper soil portion 11 once affixed, with the exception of an outwardly extending cupped protrusion 25, which provides an inwardly descending open recess 20 that permits the implementation of water into the created enclosed hollow 19, without requiring detachment. The cupped protrusion 25 would also act as an overflow outlet, ensuring over-saturation of soil, which can be fatal to a plant, will not happen.

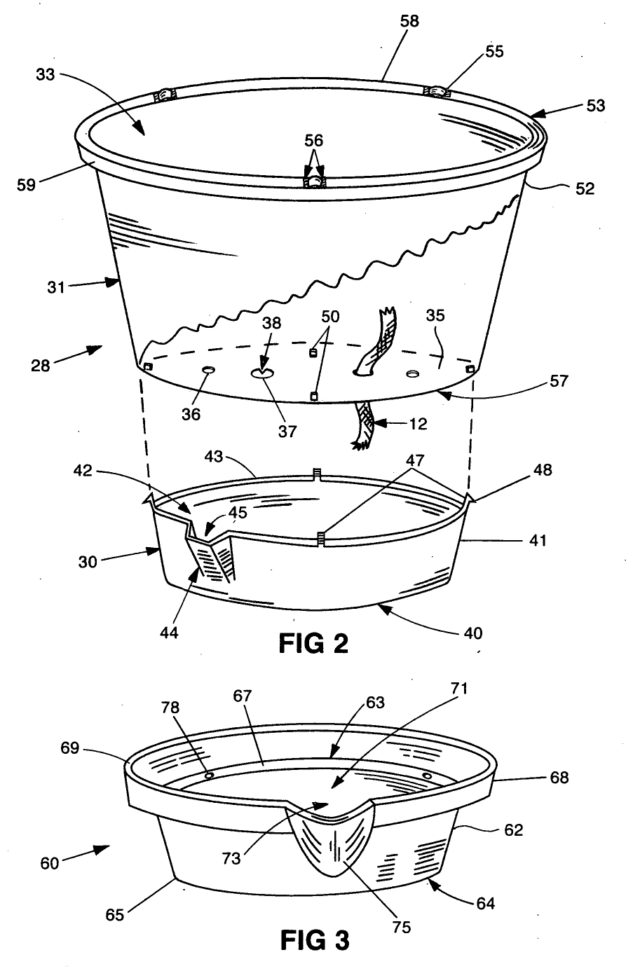

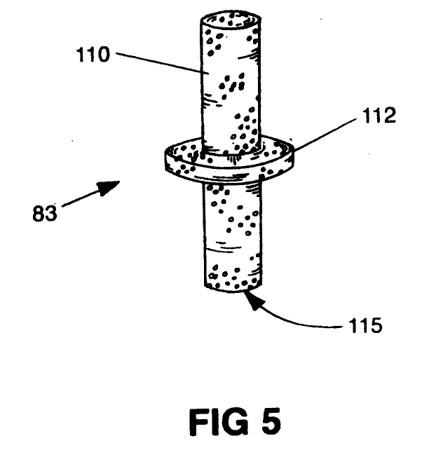

Ultimately extracting stored water from the reservoir portion 14, and dispersing the water upwardly into the soil portion 11 is accomplished by another piece of the assembly known to be an absorptive matter portion 12, resembling a cord or a rope as shown in FIG. 2, although it should be recognized the absorptive matter portion 12 may be of sponge or another suitable substance (reference FIG. 5) capable of wicking water and conformable for implementation into assembly of embodiment 9.

With further attention directed to FIG. 2, another preferred embodiment or receptacle 28 similar to that of FIG. 1 is shown, revealing on absorptive matter portion 12 captured in the base area 35 of the upper soil portion 31. Openings 37 having an inwardly projecting prong 38 or serrated edge of sort, would act to restrain the absorptive matter portion 12 at a midway point of its overall length, insuring moisture absorption from any depth within the water reservoir portion 30, and appropriate distribution into upper soil portion 31.

The amount of water draw or wick action required by the absorptive matter portion 12 would be determined by a plant's water intake, soil moisture evaporation, and also variations in overall size of the presently preferred embodiments including those in FIGS. 1, 2, 4, and 6. Wherefore the quantity and size of an absorptive matter portion 12 may be adjusted accordingly.

The reservoir portion 30, being round in nature, has a flat bottom area 40, whereat the outermost circumference, a sidewall 41 casts upwardly, ending with a lip 43, thus forming a bowl of sort, whereby a large downwardly extending open recess 42 is created which also extends outwardly from said sidewall 41 to include an adjoining area of recess 45 developed by a semi-cupped protrusion 44 enabling a volume of water to be held.

Projecting upwardly from the lip 43 of the sidewall 41 on the reservoir portion 30 are fastening hooks 47, having an outwardly and downwardly extending resilient barbed protrusion 48, which when introduced into the hook receiving holes 50 within the base 35 of the upper soil portion 31 would establish attachment. Although, it should be noted that the barbed end 48 on the fastening hooks 47 could be appropriately positioned to point to any side, as well as, fastening hooks 47 may yield multiple projecting barbed ends 48, to ensure secure attachment.

Once coupled, the sidewall 52 of the soil portion 31 would be flush or slightly stepped outward from the sidewall 41 of the reservoir portion 30, allowing the open recess 45 created by the cupped protrusion 44 on the reservoir 30 to protrude outwardly from the embodiment 28 permitting water to be administered into the reservoir portion 30, exclusively.

In the base 35 of the soil portion 31, small holes 36 may also be implemented to increase oxygen supply to the soil contained in the created basin 33.

The soil portion 31 includes a rim 53 which juts outwardly from the top of the sidewall 52 and includes indentations 55 having one or more cavities 56 for optional hanger 18 attachment. The indentations 55 residing on the top surface 58 of the rim 53, could accordingly be situated on the outer edge 59 of the rim 53, and may or may not include cavity 56.

With further attention directed to FIG. 3, an optional water reservoir portion 60 is shown, wherein the lower extremity 57 of the soil portion 31, shown in FIG. 2 for example, would nestle in a concave 63 formed in the sidewall 62. The reservoir portion 60 would generally be solid in nature, having a spherical base 64, by wherein, the outer edge 65 would turn upwardly and continue to form a sidewall 62. At any given height the sidewall 62 would ultimately jut outwardly creating an inner ledge 67, then turn upwardly again for a distance, creating a support wall 68 ending with a lip 69.

A descending area of recess 71 is thus formed, wherefrom the lip 69 to and including the ledge 67, act as an area of vertical and horizontal support to cradle the upper soil portion 31, and wherefrom the ledge 67 to the base 64, a large volume of water can be contained for the absorptive matter portion 12 to wick water.

A cup shaped protrusion 75 in the sidewall 62 establishes an added area of recess 73 which adjoins to the recess 71 to permit the implementation of water into the reservoir 60 without the removal of the upper soil portion 31.

Drainage holes 78 placed on the ledge 67 would funnel excess water out of the reservoir 60, to overt over-saturation of soil contained in soil portion 31.

The reservoir 60 may be conformed also to handle the variable soil embodiment portions of FIGS. 1, 4, and 6.

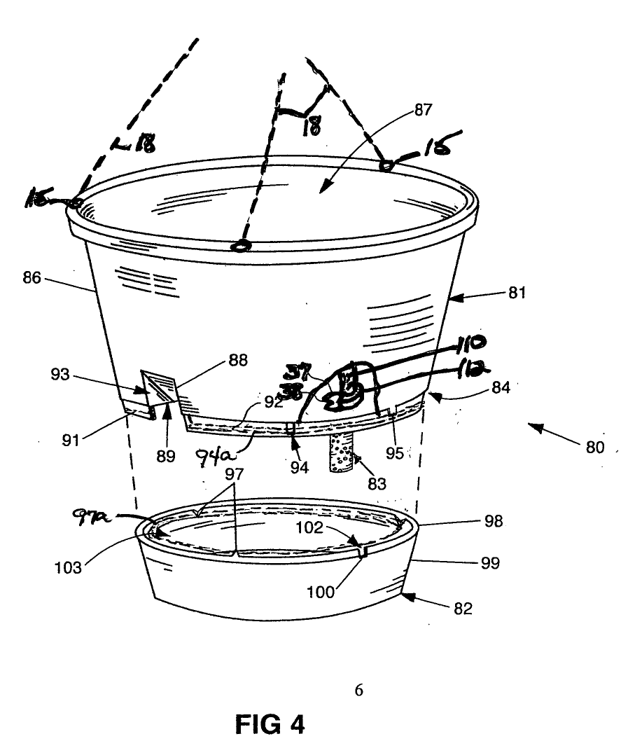

FIG. 4 shows an isometric view of another alternative multi-piece self watering plant receptacle 80, having an upper soil portion 81, wherein a sidewall 86 is a depression 88 which produces an inwardly and downwardly descending area of recess 93, that extends into and through a portion of the base 89. Also, wherefrom the base 89 outer region, a ledge 91 of sort projects downwardly, producing an inward step 84, from the sidewall 86. The ledge 91 contains points of open or inward indented recess 94 on the outer face 92, and a protruding key 95 of sort that would aid to properly align and affix the water reservoir portion 82.

The reservoir portion 82 in conjunction to the ledge 91 has inward protrusions 97 on the uppermost region 98 of the sidewall 99, and a slot 100 having an area of open recess 102 that would work in unison with the key 95 on the soil portion sidewall 86 to ensure proper alignment of the areas of recess 94 and the protrusions 97, for attachment.

Once adjoined the step 84 would endorse a flush mating, encompassing the sidewall 99 on the reservoir portion 82, to that of sidewall 86 of the soil portion 81.

The recess 94 may encircle the ledge 91 on the soil portion 81, as could the protrusions 97 surround the uppermost region 98 of the water reservoir portion 82 in an effort to eliminate the key 95 and slot 100.

When coupled, the recess 93 created by the depression 88 would allow water to be dispensed into the basin 103 of the water reservoir portion 82 and be drawn upwardly into the soil portion 81, basin 87, by an absorptive matter portion 83 projecting from the base 89. The absorptive matter portion 83, containment hole (not shown) would be similar to that of opening 37 in FIG. 2.

With further attention directed to FIG. 5, an isometric view of an alternative absorptive matter portion 83 is shown, consisting of a shaft 110 having uniform ends 115 wherefrom a midway point of the overall length, a protrusion 112 juts outwardly. The protrusion 112 would act to arrest further progress of the shaft 110 once either end 115 is inserted for example through an opening 37 within the base 35 of the upper soil portion 31 in FIG. 2, thus allowing the absorptive matter portion 83 to suitably extend upwardly and downwardly from the base 35, so as when the water reservoir portion 30 is attached, the act of drawing water from the recess 42 upwardly into the basin 33 of the soil portion 31 to replenish moisture content of contained soil is thus accomplished. The absorptive matter portion 83 in a current form notably would be inserted though an opening 37 from the basin 33 of the upper soil portion 31. Knowing this, the shaft portion 110 could project solely from one side of the protrusion 112 as well as multiple legs, that would be accommodated by coordinated openings 37 in the base 35 of the soil portion 31, wherefore the protrusion 112 would act to disperse water to contained soil, from the shaft 110 or multiple legs which would reside in the recess 42 of the reservoir 30, once affixed (although not shown).

It is also pertinent that the shaft portion 110 of the absorptive matter portion 83 having a protrusion 112 may emit alternative projections at variable points (not shown) which would allow the implementation and capture into an opening 37 in the base 35 of the soil portion 31 and whereby the angle of insertion may vary.

The alternative absorptive matter portion 83 would be of a sponge or a compressed type material, manufactured in a conceivable form for the implementation into FIGS. 1, 2, 4 and 6, for the act of wicking water. Although, too, one particular alternative absorptive matter portion 83 is shown, and others are mentioned, it is to be appreciated a variety of wicking methods may be accommodating by appropriate forms.

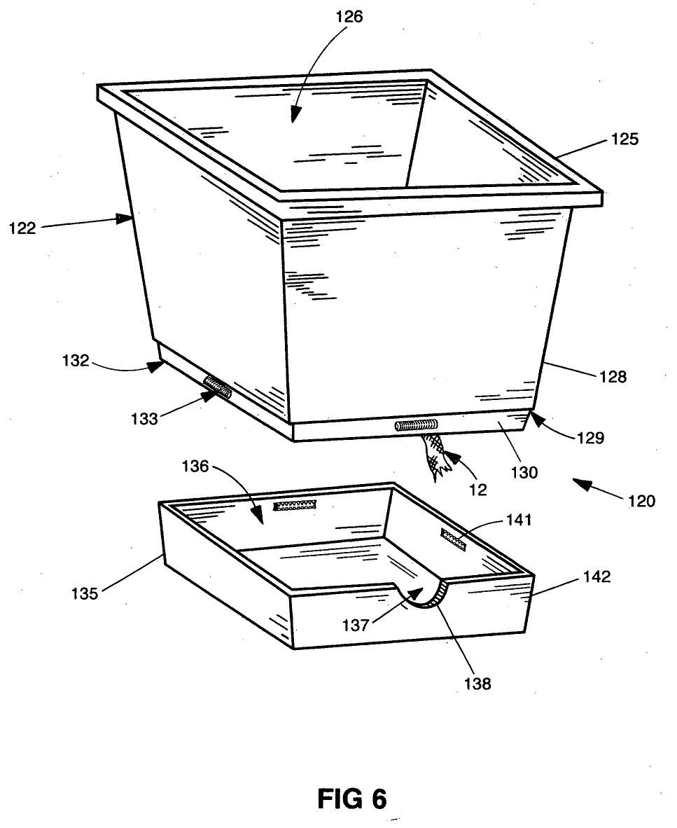

Lastly, FIG. 6, shows another self watering plant receptacle 120 like that of FIGS. 1, 2, and 4, wherein the absorptive matter portion 12 extends from the base 132 of the upper soil portion 122, and an attachable water reservoir 135 has an opening 138 in the sidewall 142 for the implementation of water, but whereas the overall shape of the receptacle 120 is square shaped.

The upper soil portion 122 being square in nature has sidewalls 128 which cast upwardly from the base 132, and, whereat an uppermost point turn outwardly and downwardly forming a rim 125, thus creating a descending open recess 126.

A recession on the lower region of the soil portion 122 sidewalls 128 forms a trunk 130 of sort, including protrusions 133. The protrusions 133 would adjoin into recess points 141 on the inside of sidewalls 142 of the box shaped water reservoir portion 135. Once coupled, the step 129 would allow a flush mating of sidewalls 128 and sidewalls 142 outer surface areas, excluding an area of recess 137 formed by the opening 138, which would allow access to implement water into the now enclosed area of recess 136, permitting the absorptive matter portion 12 to wick water accordingly into the upper soil portion 122 of the receptacle 120.

While the present invention has been described with respect to a number of presently preferred embodiments, it is to be appreciated that still other embodiments and modifications thereto might be suggested to those of skill in the art.

Accordingly, it is contemplated that the following claims should be interpreted to include all those equivalent embodiments within the spirit and scope of the invention.

What is claimed is:

1. Self watering plant receptacle comprising:
a) a soil container having bottom and sidewalls that define a first cavity, and wherein a surface of said soil container sidewall includes a continuous first fastener portion that completely circumscribes said sidewall
b) a water reservoir having bottom and sidewalls that define a second cavity, and wherein a surface of the water reservoir sidewall includes a continuous second fastener portion that completely circumscribes the sidewall of said water reservoir and that interlocks with said first fastener portion to detachably couple said soil and water containers to one another; and
c) a wick member comprising a porous material having an elongated shaft portion and a flange portion radiating from said shaft portion intermediate a first end that mounts in said first cavity and a second end that mounts in said second cavity and wherein said wick member is directly coupled to the storage container bottom wall and wherein said flange portion projects sufficiently to prevent movement of said wick member past the bottom wall of said soil container, thereby defining the exposure of said first end in said first cavity.

2. Apparatus as set forth in claim 1 wherein said soil container includes a flange that depends from said bottom wall and nests into said water reservoir and wherein an exterior wall of said flange supports said first fastener portion and fastens to the interior sidewall of said water reservoir.

3. Apparatus as set forth in claim 1 wherein one of the first and second fastener portions comprises a channeled recess and the other of said first and second fastener portions comprises a projection that interlocks with the channeled recess.

4-5. (canceled)

6. Apparatus as set forth in claim 1 wherein said first and second fastener portions are endless.

7. Apparatus as set forth in claim 2 wherein said plant receptacle includes an opening defined by an acute surface portion relative to the bottom wall of said soil container that communicates with said second cavity.

8. Apparatus as set forth in claim 1 wherein a perimeter portion of the wick supporting aperture in the bottom wall of said soil container defines a single pointed prong that projects to directly affix said wick member to said soil container.

9-10. (canceled)

11. Apparatus as set forth in claim 1 wherein said wick member comprises a compressible material having a cylindrical shaft and a concentric cylindrical flange displaced between said first and second ends of said shaft.

12-26. (canceled)

27. Apparatus as set forth in claim 11 wherein said wick comprises a sponge material.

28. Apparatus as set forth in claim 1 wherein one of said first and second fastener portions comprises an endless chanelled recess and the other comprises an endless complementary projection that fits into said recess.

29. Apparatus as set forth in claim 1 including a hanger and wherein a peripheral open edge portion of said soil container is adapted to couple to said hanger.

30. Self watering plant receptacle comprising:
a) a soil container having bottom and sidewalls that define a first cavity, wherein a flange depends from the bottom wall of said soil container, wherein said flange includes an endless first fastener portion;
b) a water reservoir having bottom and sidewalls that define a second cavity, wherein said flange nests into said water reservoir, wherein an acutely angled opening is provided in said receptacle in communication with said second cavity to direct water into said second cavity, wherein said water reservoir includes an endless second fastener portion that interlocks with said first fastener portion to couple said soil container and water reservoir together, and wherein said first and second fastener portions define a recessed channel and a mating projection; and
c) a wick member comprising a porous compressible material having an elongated shaft portion defining first and second ends that respectively lie in said first and second cavities and a flange portion radiating from said shaft portion intermediate said first and second ends and directly coupled to a single pointed prong that projects from a perimeter surface of an aperture in the soil container bottom wall.

31. Apparatus as set forth in claim 30 wherein said wick member comprises a cylindrical shaft portion and a cylindrical flange portion that radiates sufficiently from said shaft portion to abut the bottom wall of said soil container and limit the extension of said second end into said second cavity.

32-33. (canceled)

34. Apparatus as set in claim 30 including a hanger and wherein a peripheral open edge portion of said soil container includes apertures adapted to couple to said hanger.

35. Apparatus as set in claim 30 wherein said wick member comprises a sponge material.

36. Self watering plant receptacle comprising:
a) a soil container having bottom and sidewalls that define a first cavity, wherein a flange depends from the bottom wall of said soil container, wherein said flange includes an endless first fastener portion;
b) a water reservoir having bottom and sidewalls that define a second cavity, wherein said flange nests into said water reservoir, wherein an acutely angled opening is provided in said receptacle in communication with said second cavity to direct water into said second cavity, wherein said water reservoir includes an endless second fastener portion that interlocks with said first fastener portion to couple said soil container and water reservoir together, and wherein said first and second fastener portions define a recessed channel and a mating projection;
c) a wick member comprising a porous sponge member having a cylindrical shaft portion and a cylindrical flange portion that radiates sufficiently from said shaft portion to abut the bottom wall of said soil container and limit the extension of said second end
